(19) United States
(12) Patent Application Publication
(10) Pub. No.: US 2013/0186146 A1
(43) Pub. Date: Jul. 25, 2013

(54) REDUCTION OF THE EVAPORATION RATE OUT OF PLATINUM AND Pt ALLOYS

(71) Applicants: Annette Lukas, Rodenbach (DE); David Francis Lupton, Gelnhausen (DE); Nicole Gübler, Friedberg (DE); Harald Manhardt, Bruchkobel (DE); Mark Bissinger, Schoneck (DE); Uwe Jantsch, Freigericht (DE); Stefan Vorberg, Hanau (DE)

(72) Inventors: Annette Lukas, Rodenbach (DE); David Francis Lupton, Gelnhausen (DE); Nicole Gübler, Friedberg (DE); Harald Manhardt, Bruchkobel (DE); Mark Bissinger, Schoneck (DE); Uwe Jantsch, Freigericht (DE); Stefan Vorberg, Hanau (DE)

(73) Assignee: HERAEUS MATERIALS TECHNOLOGY GMBH & CO. KG, Hanau (DE)

(21) Appl. No.: 13/878,434

(22) PCT Filed: Oct. 5, 2011
(86) PCT No.: PCT/EP11/04959

§ 371 Date: Apr. 9, 2013

(30) Foreign Application Priority Data
Oct. 11, 2010 (DE) 10 2010 047 896.2

(51) Int. Cl. B32B 17/06

(52) U.S. Cl. CPC B32B 17/061
USPC 65/374.11; 156/185

(57) ABSTRACT

Methods for reducing the evaporation rate of platinum and Pt alloys upon their use at high temperatures >1,200° C. in an oxidizing atmosphere include the steps: (A) providing a component made of platinum or a platinum alloy; (B) wrapping the outer surface of the component with a flexible bandage having open porosity and provided with an oxide ceramic material and/or a glass-forming material; (C) using the component at operating temperatures >1,200° C. Methods for scavenging noble metal oxides evaporating or sublimating from the surface of platinum or Pt alloys include: (A) providing a component made of platinum or a platinum alloy; (B) wrapping the outer surface of the component with a flexible bandage having open porosity; and (C) using the component at operating temperatures >1,200° C. Correspondingly wrapped components are also provided.

### CROSS-REFERENCE TO RELATED APPLICATIONS

This application is a Section 371 of International Application No. PCT/EP2011/004959, filed Oct. 5, 2011, which was published in the German language on Apr. 19, 2012, under International Publication No. WO 2012/048811 A1 and the disclosure of which is incorporated herein by reference.

### BACKGROUND OF THE INVENTION

The invention relates to the reduction of the evaporation rate of platinum and Pt alloys upon their use at high temperatures (>1,200° C.) in an oxidizing atmosphere.

### Definitions

Platinum shall be understood to mean a platinum material that may contain fractions of further elements as common in the industry. This concerns, in particular, inevitable impurities.

A platinum alloy shall be understood to mean an alloy having platinum as the major fraction, in particular having in excess of 80% platinum. The remainder is preferably accounted for by rhodium and/or iridium.

The evaporation rate shall be understood to mean the rate at which the loss of material occurs. It can be expressed as mass loss per operation time.

### Technical Background

Components made of platinum and PtRh10 are used for the melting and processing of glass in the glass industry. In the process, the temperatures of the components may be as high as 1,700° C. In this context, the service life of, e.g., feeder systems should be guaranteed to exceed 500 days. At high temperatures >1,200° C., platinum and rhodium are converted into volatile oxides which leads to a loss of material. Although the components are mechanically supported and surrounded in a thermally insulating manner by ceramic blocks, which concurrently affords a certain protection from oxidation, the evaporation rates are considerable. The loss of material increases markedly with temperature. This leads to a rapid decrease in the wall thickness which reduces the service life of the components drastically.

In laboratory experiments of the applicant using uncoated PtRh10 sheets of metal (thickness=0.8 mm) at 1,650° C. in air, approx. 4% loss of material over the period of 20 days has been observed to occur. Even a reduction of the temperature to 1,600° C. still leads to 2.4% loss of material over the period of 20 days. In use, evaporation rates of this magnitude lead to early failure of the component.

### Prior Art

International patent application Publication No. WO 2002/044115 A2, U.S. Pat. No. 7,338,714 B2, and European patent application Publication EP 1 722 008 A2 are related to a coated metal part in glass manufacturing, wherein the metal part has, on its side facing the molten glass, a layer that is impermeable to H₂ or H₂ and O₂.

In this context, preferably either the H₂— or the H₂— and O₂— impermeable layer contains at least one glass or glass mixture, partly or fully crystallized or ceramic material.

### SUMMARY OF THE INVENTION

In contrast, it is an object of the invention to provide a scavenging system for Pt, Rh or Ir in an oxidizing atmosphere at high temperatures. The surrounding ceramic layers should largely be kept free of noble metals.

It is another object of the invention to provide for prolongation of the service life and thus time of use of noble metal components made of platinum or alloys thereof during their use at high temperatures (>1,200° C.) in an oxidizing atmosphere—preferably by more than 80%.

For reduction of oxidation and ensuing losses of materials, an oxidation protection system has been developed that can surprisingly also be applied without any difficulty to very large components having a complex geometry. A flexible bandage made of a high-melting ceramic or metallic material has proven to be advantageous.

The objects are each met by components as well as by methods of the present invention described and claimed herein, including the preferred embodiments of the invention described below.

In this context, a bandage is characterized by its open porosity and preferably a large internal surface. An oxide ceramic material and/or a glass-forming material matched to the temperature of use can be introduced into the pores of the bandage. Note that network-forming materials, also called glass-forming materials, form the basic molecular structure of glass. No further substances are required for glass formation. Accordingly, quartz glass, for example, has SiO₂ as its sole component. The following compounds are examples of network-forming materials: silicon dioxide (SiO₂), boric trioxide (B₂O₃), phosphorous pentoxide (P₂O₅), diarsenic trioxide, also called arsenic trioxide (As₂O₃), germanium dioxide (GeO₂), and diantimonypentoxide (Sb₂O₅).

This bandage involves a “soaked bandage” in the scope of the invention. The soaked bandage can be produced by soaking in or drop-wise application of or painting with a suspension. Components wrapped with the bandages afford the opportunity to completely wet the surface of the component at operating temperature and impede the access of oxygen. Complete wetting for long periods of time appears to be feasible only through the use of a bandage of this type. This is a particular advantage of the invention. The evaporation losses as compared to non-bandaged components are preferably reduced by more than 80%.

Due to the open porosity, non-soaked bandages are permeable to air and thus have little or no protective effect against an oxidizing atmosphere. Moreover, the adherence on components is rather insufficient due to thermal expansion. However, non-soaked bandages allow for scavenging noble metal oxides that escape despite evaporation protection. It is also feasible to first wrap with a soaked bandage and then with a non-soaked bandage over the first bandage.

The advantages of soaked bandages are:
easy to install even on the finished component;
easy to remove;
take-up of PtO₂ and similar oxides, protection of surrounding ceramic material from taking-up such oxides. This allows to simply submit the bandage to recycling, rather than the ceramic blocks, in order to recycle the noble metals contained in the oxide loss;
complete wetting of the entire component;
stability and/or resistance of the wetted layer for a long period of time;
reduction of evaporation losses by more than 80% as compared to unprotected material;
the bandage fixes the glass-forming material, if any, on the component; and
the components do not need to be subjected to mechanical pre-treatment (e.g. sand-blasting).

### DETAILED DESCRIPTION OF THE INVENTION

The invention is illustrated in more detail by the following exemplary embodiments. As is the case in the remaining description, specification of parts and percentages refer to the weight unless specified otherwise.

### Example 1

Application of a protective bandage made of a ceramic material (Al₂O₃+28% SiO₂) onto a PtRh10 sheet of metal having dimensions of: width 150 mm, length 200 mm, wall thickness 0.8 mm.

The bandage (thickness 5 mm) was soaked in a suspension consisting of Al₂O₃ powder (particle size: <2.5 μm) and water (30% by weight Al₂O₃ and 70% by weight water) and wrapped around the sheet of metal in 2 layers.

The sheet of metal was aged in a chamber furnace for 20 days at 1,650° C. on air.

The loss of material (PtRh10 sheet of metal) was 0.6%.

### Example 2

Application of a protective bandage made of a ceramic material (Al₂O₃+28% SiO₂) onto a Pt Rh 10 sheet of metal having dimensions of: width 150 mm, wall thickness 0.8 mm, length 200 mm.

The bandage (thickness 5 mm) was wrapped around the sheet of metal in 2 layers. A suspension of Al₂O₃ powder (particle size: <2.5 μm) and water (30% by weight Al₂O3 and 70% by weight water) was applied to the bandage.

The sheet of metal was aged in a chamber furnace for 20 days at 1,650° C. on air.

The loss of material (PtRh10 sheet of metal) was 0.9%.

### Example 3

Application of a protective bandage made of a ceramic material (Al₂O₃+28% SiO₂) onto a Pt Rh 10 sheet of metal having dimensions of: width 150 mm, wall thickness 0.8 mm, length 200 mm.

The bandage (thickness 5 mm) was soaked in a suspension consisting of ZrO₂ powder containing 5% Y₂O₃ (particle size: <5.5 μμm) and water (40% by weight ZrO₂/Y₂O₃ and 60% by weight water) and wrapped around the sheet of metal in 2 layers.

The sheet of metal was aged in a chamber furnace for 20 days at 1,650° C. on air.

The loss of material (PtRh10 sheet of metal) was 1.1%.

### Example 4

Application of a protective bandage made of a ceramic material (Al₂O₃+28% SiO₂) onto a Pt Rh 10 sheet of metal having dimensions of: width 150 mm, wall thickness 0.8 mm, length 200 mm.

The bandage (thickness 5 mm) was soaked in a suspension consisting of SiO₂ powder (particle size: <2 μm) and water (30% by weight SiO₂ and 70% by weight water) and wrapped around the sheet of metal in 2 layers.

The sheet of metal was aged in a chamber furnace for 20 days at 1,650° C. on air.

The loss of material (PtRh10 sheet of metal) was 0.5%.

### Example 5

Application of a protective bandage made of a Pt Rh 10 gauze and/or fleece onto a Pt Rh10 sheet of metal having dimensions of: width 150 mm, wall thickness 0.8 mm, length 200 mm.

The bandage (thickness approx. 0.5 mm) was wrapped around the sheet of metal. A suspension consisting of SiO₂ powder (particle size: <2.5 μm) and water (30% by weight SiO₂ and 70% by weight water) was applied to the bandage with a brush.

The sheet of metal was aged in a chamber furnace for 20 days at 1,650° C. on air.

The loss of material (PtRh10 sheet of metal) was 0.9%.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-15. (canceled)

16. A component made of platinum or a Pt alloy, wherein the component is subjected to an oxidizing atmosphere at temperatures >1,200° C., the component being wrapped with a flexible bandage having open porosity, wherein the bandage is provided with one of (a) a glass-forming material and (b) an oxide ceramic material and a glass-forming material.

17. The component according to claim 16, wherein the bandage comprises a high-melting oxide material.

18. The component according to claim 16, wherein the bandage comprises Al₂O₃.

19. The component according to claim 16, wherein the bandage comprises a noble metal gauze or fleece.

20. The component according to claim 19, wherein the gauze or fleece comprises platinum or platinum-rhodium.

21. The component according to claim 16, wherein the glass-forming material is selected from the group consisting of silicon dioxide, diboric trioxide, diphosphorus pentoxide, germanium dioxide, and diantimony pentoxide.

22. The component according to claim 16, wherein the oxide ceramic material is selected from the group consisting of Al₂O₃; ZrO₂; SiO₂.ZrO₂; SiO₂; HfO₂; CaO; MgO; and rare earth metal oxides.

23. A method for scavenging noble metal oxides evaporating or sublimating from a surface of platinum or Pt alloys, the method comprising steps of:
1. providing a component made of platinum or a platinum alloy;
2. wrapping an outer surface of the component with a flexible bandage having open porosity, wherein the bandage is provided with one of (i) a glass-forming material and (ii) an oxide ceramic material and a glass-forming material; and
(c) using the wrapped component at operating temperatures >1,200° C.

24. The method according to claim 23, wherein the bandage comprises a high-melting oxide material.

25. The method according to claim 24, wherein the high-melting oxide material is selected from the group consisting of Al₂O₃; mullite; hafnium oxide; lanthanum oxide; ZrO₂; ZrO₂.SiO₂; SiO₂; rare earth oxides; and mixtures of said oxides.

26. The method according to claim 23, wherein the bandage comprises Al₂O₃.

27. The method according to claim 23, wherein the bandage comprises a noble metal gauze or fleece.

28. The method according to claim 27, wherein the gauze or fleece comprises platinum or platinum-rhodium.

29. The method according to claim 23, wherein the glass-forming material is selected from the group consisting of silicon dioxide, boric oxide, phosphorus pentoxide, germanium dioxide, and diantimony pentoxide.

30. A method for reducing the evaporation rate of platinum and Pt alloys upon their use at temperatures >1,200° C. in an oxidizing atmosphere, the method comprising steps of:
A providing a component made of platinum or a platinum alloy;
B wrapping an outside of the component with a flexible bandage having open porosity provided with one of (i) a glass-forming material and (ii) an oxide ceramic material and a glass-forming material; and
C using the wrapped component at operating temperatures >1,200° C.

31. The method according to claim 30, wherein the bandage comprises a high-melting oxide material.

32. The method according to claim 31, wherein the high-melting oxide material is selected from the group consisting of Al₂O₃; mullite; hafnium oxide; lanthanum oxide; ZrO₂; ZrO₂.SiO₂; SiO₂; rare earth oxides; and mixtures of said oxides.

33. The method according to claim 30, wherein the bandage comprises Al₂O₃.

34. The method according to claim 30, wherein the bandage comprises a noble metal gauze or fleece.

35. The method according to claim 34, wherein the gauze or fleece comprises platinum or platinum-rhodium.

36. The method according to claim 30, wherein the glass-forming material is selected from the group consisting of silicon dioxide, boric oxide, phosphorus pentoxide, germanium dioxide, and diantimony pentoxide.
